(19) United States
(12) Patent Application Publication
(10) Pub. No.: US 2018/0293196 A1
(43) Pub. Date: Oct. 11, 2018

(54) System, Apparatus And Method For Link Training For A Multi-Drop Interconnect

(71) Applicant: Intel Corporation, Santa Clara, CA (US)

(72) Inventors: Amit Kumar Srivastava, Penang (MY); Duane G. Quiet, Hillsboro, OR (US); Kenneth P. Foust, Beaverton, OR (US)

(21) Appl. No.: 15/483,079

(22) Filed: Apr. 10, 2017

(51) Int. Cl. G06F 13/364; G06F 13/42; G06F 13/40

(52) U.S. Cl. CPC G06F 13/364; G06F 13/404; G06F 13/4282

(57) ABSTRACT

In one embodiment, a host controller includes a read controller to adjust internal clock timing based on a timer value associated with a first device and communicate information on an interconnect with the first device according to the adjusted clock timing. Other embodiments are described and claimed.

### TECHNICAL FIELD

Embodiments relate to communication via multi-drop bus structures.

### BACKGROUND

Many different types of known buses and other interfaces are used to connect different components using a wide variety of interconnection topologies. For example, on-chip buses are used to couple different on-chip components of a given integrated circuit (IC) such as a processor, system on a chip or so forth. External buses can be used to couple different components of a given computing system either by way of interconnect traces on a circuit board such as a motherboard, wires and so forth.

A recent multi-drop interface technology is an Improved Inter Integrated Circuit (I3C) Specification-based bus, expected to become available from the Mobile Industry Processor Interface (MIPI) Alliance™ (www.mipi.org). This interface is expected to be used to connect devices, such as internal or external sensors or so forth, to a host processor, applications processor or standalone device via a host controller or input/output controller.

### BRIEF DESCRIPTION OF THE DRAWINGS

FIG. 1 is a block diagram of a system in accordance with an embodiment of the present invention.

FIG. 2 is a block diagram of a system in accordance with another embodiment of the present invention.

FIG. 3 is a flow diagram of a method in accordance with an embodiment of the present invention.

FIG. 4 is a flow diagram of a method in accordance with another embodiment of the present invention.

FIG. 5 is a timing diagram illustrating various signals in accordance with an embodiment of the present invention.

FIG. 6 is an embodiment of a fabric composed of point-to-point links that interconnect a set of components.

FIG. 7 is an embodiment of a system-on-chip design in accordance with an embodiment.

FIG. 8 is a block diagram of a system in accordance with an embodiment of the present invention.

### DETAILED DESCRIPTION

In various embodiments, techniques are provided to realize greater flexibility in various systems for enabling greater types of devices to be coupled via interconnects of potentially longer length. More specifically, embodiments provide techniques for performing link training to identify particular propagation delays inherent in communications between devices coupled to the interconnect. In this way, delay information obtained during such link training may be used to dynamically control clocking for bus communication operations, including read and write operations. As will be described further herein, in some cases a bus master may be configured to perform dynamic delay determination operations and appropriate configuring of read and write communications based at least in part on such delay information.

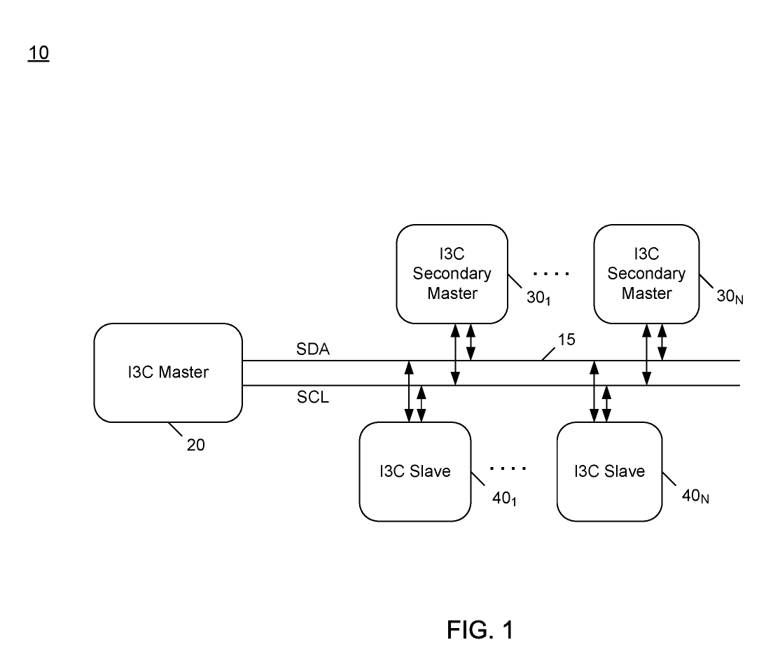

Referring now to FIG. 1, shown is a block diagram of a system in accordance with an embodiment of the present invention. More specifically, system 10 shown in FIG. 1 represents at least a portion of any one of a variety of different types of computing devices. In different embodiments, such computing devices can range from relatively small low power devices such as a smartphone, tablet computer, wearable device or so forth, to larger devices such as laptop or desktop computers, server computers, automotive infotainment devices and so forth. In any case, system 10 includes a bus 15. In embodiments herein, bus 15 may be implemented as an I3C bus in accordance with the forthcoming I3C specification. However, understand the scope of the present invention is not limited in this regard and in other embodiments, bus 15 may be implemented as any type of multi-drop interconnect.

As illustrated, a primary or main master device 20 couples to bus 15. In various embodiments, master device 20 may be implemented as a host controller that includes hardware logic to act as a bus master for bus 15. Master device 20 may include a controller (not shown in the high level view of FIG. 1) to control data (SDA) and clock (SCL), as well as use (e.g.,) internal current sources or passive pullups to hold bus 15 when all coupled devices are powered off. In some cases, master device 20 may be a relatively simple host controller for a low complexity bus or other multi-drop bus, such as in accordance with an I²C or I3C Specification. Other multi-drop interfaces such as Serial Peripheral Interface and/or Microwire also may be present in a particular embodiment.

In different implementations, master device 20 may be an interface circuit of a multicore processor or other system on chip (SoC), application processor or so forth. In other cases, master device 20 may be a standalone host controller (such as a given integrated circuit (IC)) or main master device for bus 15. And of course other implementations are possible. In other cases, master device 20 may be implemented as hardware, software, and/or firmware or combinations thereof, such as dedicated hardware logic, e.g., a programmable logic, to perform bus master activities for bus 15.

Note that bus 15 is implemented as a two-wire bus in which a single serial line forms a data interconnect and another single serial line forms a clock interconnect. As such, data communications can occur, e.g., in bidirectional manner and clock communication can occur in a single direction. Master device 20 may be a relatively compute complex device (as compared to other devices on bus 15) that consumes higher power than other devices coupled to bus 15.

As shown in FIG. 1, multiple secondary master devices 30₁-30_{N} are present. In various embodiments, secondary master devices 30 (generically) may be implemented as dedicated master or bridge devices such as standalone IC's coupled to bus 15. In other cases, these devices may be independent logic functionality of a SoC or other processor (and in some cases may be implemented in the same IC as master device 20 known as a secondary master). As will be described herein one or more such secondary master devices 30 may be controlled to act as bus master for bus 15 while main master device 20 is in a low power state, to enable bus operations to continue to proceed while in this low power state.

As further illustrated in FIG. 1, a plurality of slave devices 40₁-40_{N} also couple to bus 15. In different embodiments, slave devices 40 (generically) may take many different forms. For purposes of discussion herein, it may be assumed that slave devices 40 may be always on (AON) devices, such as sensors like micro-electrical mechanical systems (MEMS), imaging sensors, peer-to-peer devices, debug devices or so forth. Understand while shown at this high level in the embodiment of FIG. 1, many variations and alternatives are possible.

During read operations on bus 15, a timing window available for performing a read is nearly half of the bus period (T_{period}) and can be defined as: T_{busavail}=T_{scomaster} T_{pd15}+T_{scoslave}+T_{skew-jitter}+Tₛₑₜᵤₚₜᵢₘₑ<=D*T_{period} [Eq. 1], where T_{scomaster} is the bus master propagation delay time which in an example may be approximately 3 nanoseconds (ns), T_{scoslave} is the slave device response time (e.g., a 10 ns maximum per a given specification or more in some proprietary devices), T_{pd15} is a signal return path from the main master to the slave 30_{N} or 40_{N} and back to the main master, Tₛₑₜᵤₚₜᵢₘₑ is a setup time (which in an example may be approximately 3 ns) for the master, D is a duty cycle factor which could be range from 0.4-0.6 depending on duty cycle requirement, and T_{skew-jitter} is a time allocated for skew and jitter (e.g., 3 ns). In an example without an embodiment, this leaves nearly an approximate 13 ns turn-around time margin or 6.5 ns time for a signal to travel from master 20 to slave 40_{N} or 30_{N}. Due to impedance mismatches (and also the location of slave 40 from master 20), signal reflection may cause additional time loss, in turn leaving only, e.g., 2 ns-4 ns time of flight margin from master 20 to slave 40_{N} or 30_{N}.

Due to read window bus available limitation times without an embodiment, many system platform topologies provide a specification limit as to a long reach platform solution. For example, a circuit board trace (FR4) may be limited to be 15-20 inches and a standard cable length limited to 0.3 meters (m)-0.5 meters depending on cable type by a given system specification. Many types of computing systems such as client, Internet of Things (IoT) and automotive applications may have longer board traces of more than 20 inches and also cable length longer than, e.g., 1 m to 5 m or more. Additionally, some proprietary slaves may have longer delays than specified in a given specification, which may also limit the slave device selection choice. Using an embodiment, a system designer is afforded the flexibility to use long reach solutions for board traces or cables (e.g., for automotive and IoT segments) without limiting the bus operating frequency.

Embodiments provide techniques to optimize bus speed for bus 15. To this end, bus master 20 may perform, e.g., during boot or otherwise, link training with each device 30, 40 to determine propagation delay information of cable/trace and slave device responses via bus 15. This delay information may thereafter be used to program one or more of a read clock and a write clock with a programmable configuration. Such adjusted clocks may be used whenever bus master 20 performs transactions with each device 30, 40.

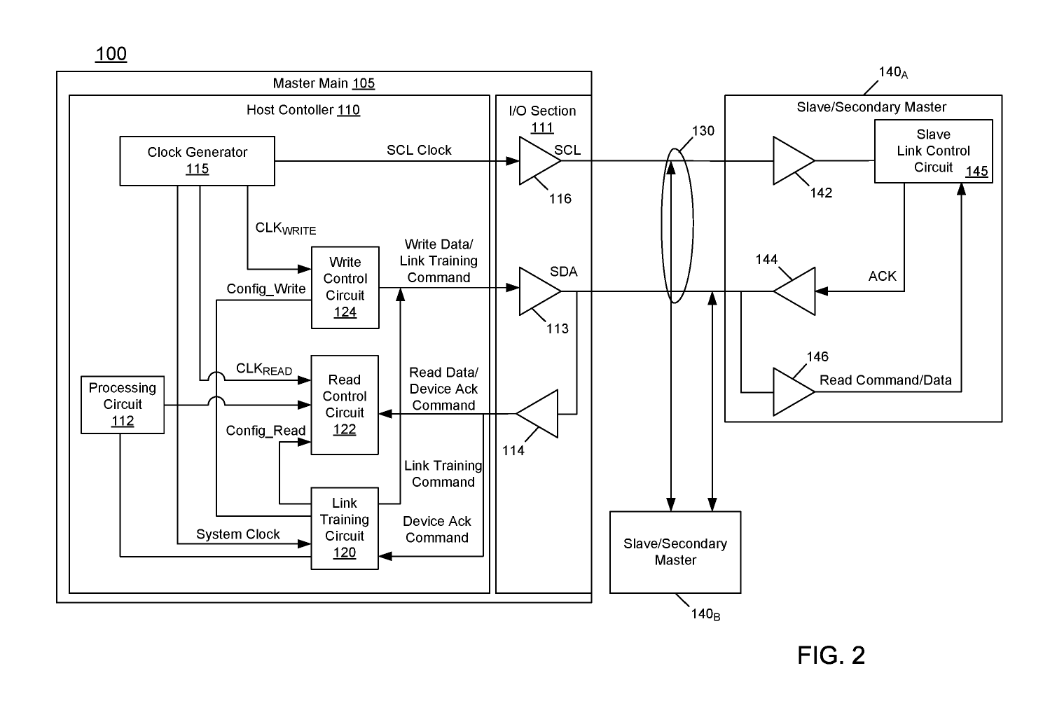

Referring now to FIG. 2, shown is a block diagram of a system in accordance with an embodiment of the present invention. As shown in FIG. 2, a portion of a system 100 includes a main master 105 including a host controller 110 coupled to a plurality of devices 140_{A}-140_{B} via a multi-drop bus 130. As further illustrated, main master 105 includes an input/output (I/O) section 111. Devices 140 (also referred to herein as “slaves”) may have different operational characteristics and also may have different capabilities of being added/removed from bus 130. As will be described herein, host controller 110 may be configured as a bus master, in at least certain operational phases. Bus 130 is implemented as a two-wire bus in which a single serial line forms a data interconnect and another single serial line forms a clock interconnect. As such, data communications can occur in bi-directional manner and clock communications can occur in a unidirectional manner.

At the high level illustrated in FIG. 2, assume that different types of devices 140 are present. Devices 140_{A-B} have, inter alia, different physical placements and electrical performance. Specifically, device 140_{A} may be always powered on and present as being coupled to bus 130. As an example, device 140_{A} may be a given type of sensor, such as an accelerometer or other sensor which may be incorporated in a given system (such as a smartphone or other mobile platform). For purposes of discussion herein, assume that device 140_{A} operates as a slave to host controller 110 (but may also be configured as a secondary bus master). With regard to communication considerations, note that device 140_{A} is relatively close to host controller 110 and thus has short traces. Given the relative proximity of device 140_{A}, in an embodiment there may be reduced delays in communications between these devices. In some embodiments, host controller 110 may selectively not adjust read/write clocks for device 140_{A} and other devices that are very near to host controller 110, and/or are meeting a read window timing.

Device 140_{B} may be powered when it is to be active. As an example, assume that device 140_{B} is another type of sensor, such as a camera device. In such example, device 140_{B} may be powered on only when a camera functionality of the system is active. In other cases device 140_{B} may be a slave device that can be physically added/removed via a hot plug or hot unplug operation, such as a cable, card, or external peripheral device that is coupled to bus 130, e.g., by a cable, external connection or so forth. In still other cases, device 140_{B} may be coupled via an in-box cable. In such cases, there may be a long distance between device 140_{B} and host controller 110. Note that device 140_{B} may be relatively further away from host controller 110 than device 140_{A}.

As illustrated in FIG. 2, host controller 110 includes a processing circuit 112. Understand that many different types of host controllers can be provided. As examples, host controller 110 may be an interface circuit of a multicore processor or other system on chip (SoC), application processor or so forth. In other cases, host controller 110 may be a standalone host controller for bus 130. And of course other implementations are possible. In different implementations, processing circuit 112 may represent one or more cores or other hardware processing logic of a particular device or it may simply be part of an interface circuit to act as transmitter and receiver for host controller 110. In turn, processing circuit 112 couples to a driver 113 that drives data onto bus 130 and a receiver 114 that receives incoming data via a data line of bus 130.

Host controller 110 further includes a clock generator 115 to provide a clock signal (and/or to receive a clock signal, in implementations for certain buses) to a clock line of bus 130 via corresponding driver 116. In various embodiments, clock generator 115 may be configured to provide additional clock signals for use in host controller 110, as described herein.

To perform the link training described herein, host controller 110 includes a link training circuit 120. Link training circuit 120 is configured to cause a dedicated link training command to be sent via driver 113 to a respective device 140. This link training command, when received within a given device 140 may cause the corresponding device 140 to cooperate in a link training process by immediately sending an acknowledgement command signal (ACK) back to host controller 110 in an expedited manner. As illustrated, device 140_{A} includes a slave link control circuit 145 that, responsive to this link training command, decodes the link training command and sends immediately an acknowledgement command via driver 144 over link 130. In this way, link training circuit 120 of host controller 110 can readily identify total propagation delay information for communications between host controller 110 and device 140_{A}, as described herein.

More specifically link training circuit 120 sends this link training command via driver 113 along the data line of interconnect 130 and to a receiver 146 that in turn provides the received link training command signal to slave link control circuit 145 for decoding and further response. In response to this signal, slave link control circuit 145 immediately sends the acknowledgement command signal via driver 144. As illustrated, this incoming signal is received within host controller 110 via a receiver 114 that provides this acknowledgement command signal back to link training circuit 120 for decoding the received ACK.

Based at least in part on the time duration from the sending of the link training command from link training circuit 120 to receipt of the acknowledgement command signal in link training circuit 120, appropriate propagation delay parameters for communications with respect to device 140_{A} may be determined. Link training circuit 120 sends configuration information, namely configuration read information (e.g., a number of configuration bits), to read circuit 122 to adjust internal read clock timing. Similarly, link training circuit 120 sends configuration information, namely the same delay estimation as configuration write information, to write control circuit 124, which can use this information to hold the next write data. Thus as seen, link training circuit 120 sends configuration information to write control circuit 124 and read control circuit 122, to control adjustment of internal timing. In an embodiment, timing adjustment could be done using flip-flop based delay generation, or in another way. As will be described further herein to enable link training circuit 120 to perform link training operations with respect to devices 140, clock generator 115 may provide a system clock signal to link training circuit 120, which may run at a much faster rate than the SCL clock.

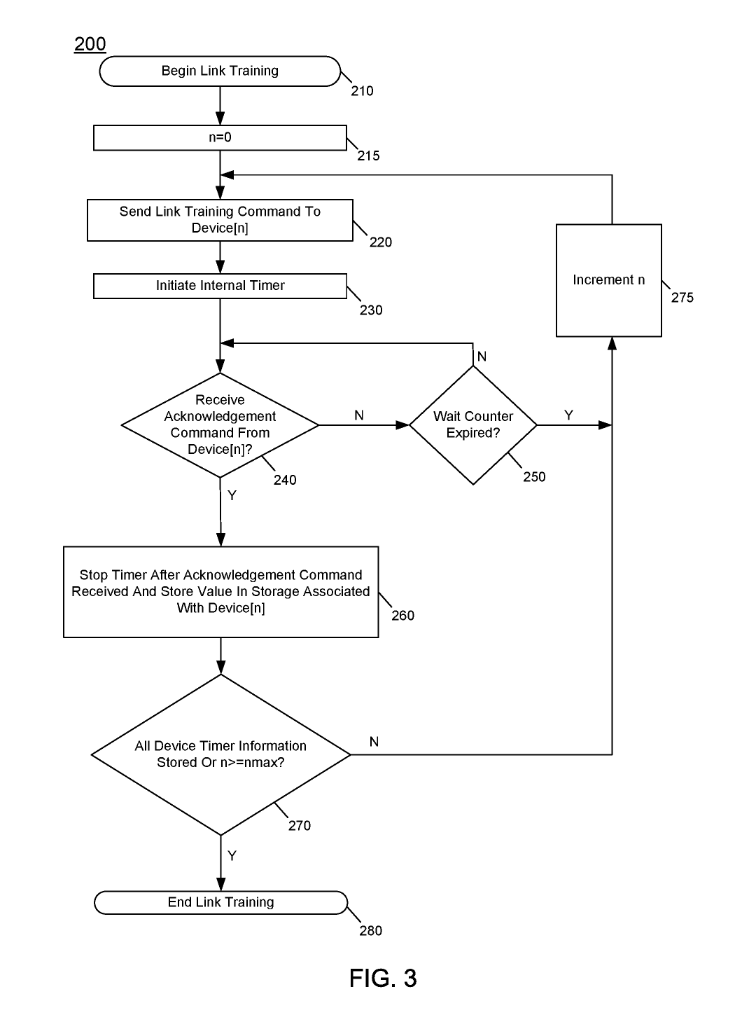

Referring now to FIG. 3, shown is a flow diagram of a method in accordance with an embodiment of the present invention. As shown in FIG. 3, method 200 may be performed by hardware, software, firmware and/or combinations thereof. In a particular embodiment, method 200 may be performed by a link training circuit of a bus master such as a host controller as described herein. Note that method 200 for link training may be performed after initialization operations on the bus have completed and one or more devices coupled to the bus have been provisioned or enumerated with addresses, such that each given device may be properly addressed. In this way, link training can be initiated for each individual device on the bus. In some cases, the link training described herein may be performed in response to any dynamic address assignment, and/or any hot join bus activity.

As illustrated, method 200 is a process for link training that initiates at block 210. First a given device is selected (n=0) (block 215). Thereafter, the host sends a link training command to the given device coupled to the host via a bus (block 220). Note that this command in an embodiment is a particular link training command. In association with sending the link training command, the host controller may initiate an internal timer to measure delay using a system clock (block 230). Note that this system clock rate may be at a much higher rate than the SCL bus clock frequency. In this way, link training can account for small variations in propagation delay for different devices coupled to the bus. In a particular embodiment where a bus clock operates at 12.5 MHz, this high frequency clock may be at many times higher than the bus clock rate. Of course other examples are possible.

Still with reference to FIG. 3, control next passes to diamond 240 to determine whether an acknowledgement command is received from the device. If not, control passes to diamond 250 to determine whether a wait counter has expired. Note that this wait counter may be set for a relatively long time period (e.g., approximately 1 ms). If this wait counter expires, this indicates that there is some type of communication problem with the given device. As such, method 200 may conclude for this device. Note that it is possible that some type of re-addressing or other error or address decoding issue or device un-plug may occur for this device. Control passes to block 275 so that another device connected to bus may begin link training by incrementing n, the count of devices.

Still with reference to FIG. 3, if instead it is determined that an acknowledgement command has been received from the device, control passes to block 260. There, the host controller stops the internal timer and obtains the present timer value that thus corresponds to a time duration between sending of the link training command to the given device and the receipt back from the device of the acknowledgment command for this link training command. This value, also referred to herein as a propagation delay time value, may be stored in a non-volatile storage (e.g., register) associated with this device within the host controller. For example, the host controller may maintain a timer table including a plurality of entries each associated with a given addressed device coupled to the bus. As described further herein, a given entry of this timer table can be accessed when a communication is to occur between the host controller and the given device. In some cases, read and write timing may be configured based on the timer value. In an embodiment, this configuration or timer adjustment may simply be through use of the propagation delay time value. In other cases, some type of scaling value may be applied to the propagation delay time value to accommodate for other delays, losses or so forth.

Still with reference to FIG. 3, control next passes to diamond 270 to determine whether all device timer information is stored (or n equals a maximum value). If so, control passes to block 280 to conclude the link training and wait for a further command from the host controller. When it is determined that link training has not yet been completed for all devices control passes to block 275 where the count can be incremented and the next device can be trained, beginning at block 220.

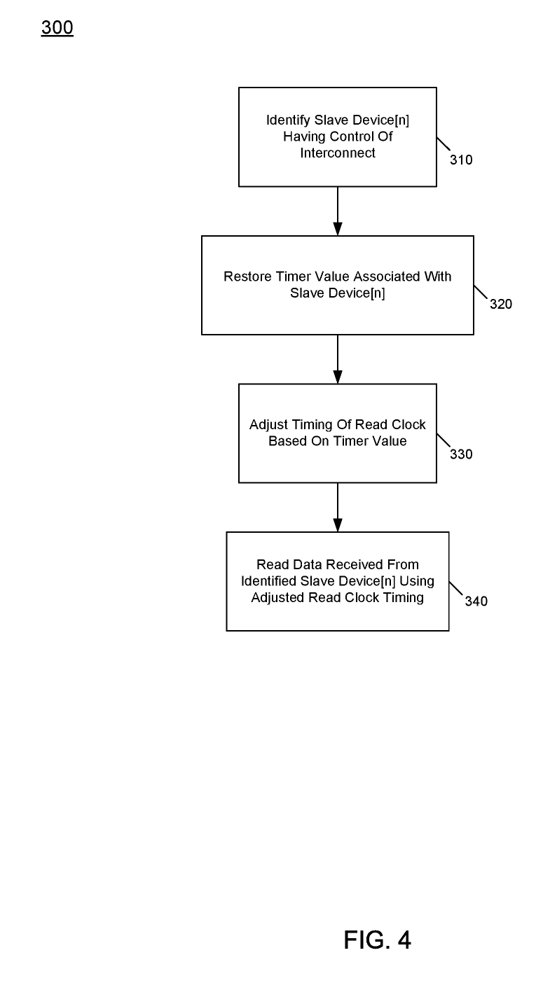

Referring now to FIG. 4, shown is a flow diagram of a method in accordance with another embodiment of the present invention. More specifically, method 300 shows a method for performing read operations in a host controller or other bus master in accordance with an embodiment of the present invention. As such, method 300 may be performed by hardware, software, firmware and/or combinations thereof, such as may be implemented within a read circuit of the host controller. As illustrated, method 300 begins by identifying a slave device having control of the interconnect (block 310). Understand that this determination may be based on an indication of a given device that has gained access to the bus, e.g., via a pulldown operation or winning bus arbitration mechanism. Control next passes to block 320 where a restoration process to read the timer information for this connected device can be accessed, e.g., from a register of the host controller space. More specifically, this timer information storage, which may be located within or associated with the host controller, can be accessed using an address or other indicator of the slave device. In an example where the timer storage is a table that includes multiple entries each associated with a given slave device, the entry associated with the slave device that obtained bus control can be accessed to obtain a timer value as a function of propagation delay information for a read and write cycle.

Still with reference to FIG. 4, control next passes to block 330 where a timing of a read clock can be adjusted based on this timer value. As one example, a timer value can be sent to a read control circuit to adjust internal clock timing, for example, through a controllable delay element (other implementations of course are possible). By way of this adjustment, a read internal clock used for performing read operations, e.g., in a read circuit of the host controller is configured for optimal read performance. Thereafter, control passes to block 340 where data received from the identified slave device may be read using this adjusted read clock timing. By way of this adjusting of timing with a dynamically controllable delay value, the read operation may be performed in a manner to ensure that accurate data is read. Note that write operations may similarly be performed, where a write clock timing can be adjusted by way of a write delay value, as applied to a controllable delay element. Although the scope of the present invention is not limited in this regard, embodiments may provide system designer flexibility for multi-drop buses to cover for long reach solution for IoT, automotive and client segments. As a result, embodiments need not reduce bus operating frequency for such systems, and can scale maximum operating frequency. Understand while shown at this high level in the embodiment of FIG. 4, many variations and alternatives are possible. For example, it is possible to adjust parameters of the read and write clocks themselves.

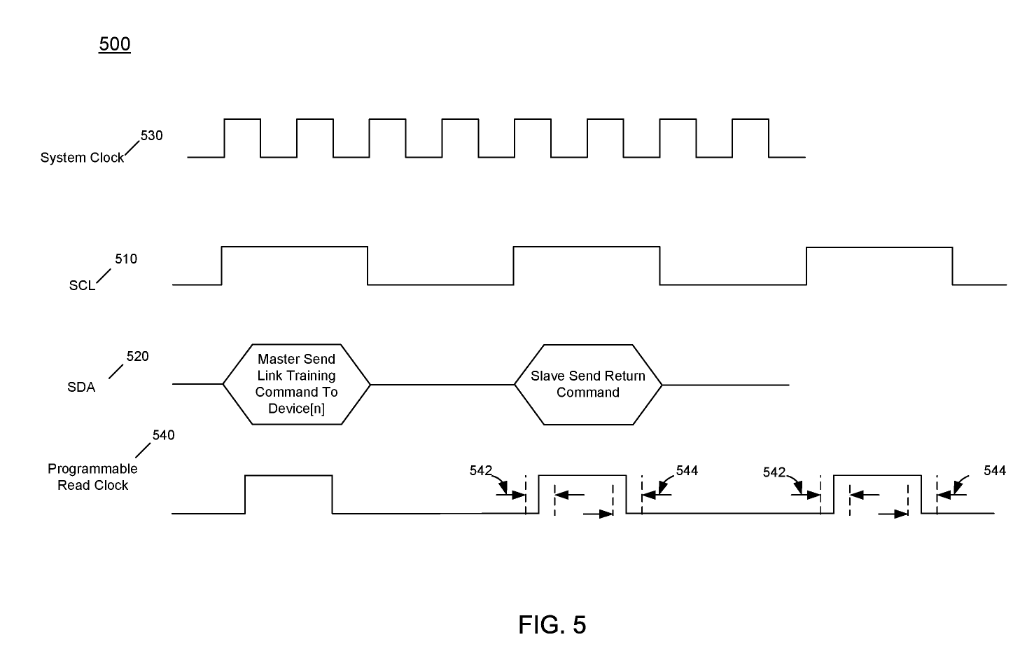

Referring now to FIG. 5, shown is a timing diagram illustrating various signals in accordance with an embodiment of the present invention. As illustrated in FIG. 5, communications on a multi-drop bus may occur according to a first clock signal 510, SCL. In an embodiment, clock signal 510 may operate at a relatively slow rate, e.g., 12.5 MHz. However, understand that in certain instances before addressing and other boot activities have completed on the bus (including the link training described herein) this first clock may operate at a lower frequency. In addition, a clock generator may generate a system clock 530. In embodiments, this clock signal may operate at much higher clock rate than the SCL clock.

As further illustrated in FIG. 5, via a SDA data line 520, a link training command can be sent to a device at a first cycle of clock SCL 510. The host controller starts an internal timer and starts counting up to the time that it has received a slave acknowledgement command from the slave device. Then the host controller stops the timer and adjusts a programmable read clock 540 (as shown in FIG. 5 for the second and subsequent clock cycles). Understand that this programmable read clock may have an adjustable delay illustrated by dashed variations 542 and 544. As such, depending upon a propagation delay time value associated with a given device to which a host controller is to communicate, programmable read clock 540 may be dynamically adjusted to vary its position, e.g., with regard to a midpoint of first clock 510 by a given propagation delay time value to move this read clock earlier with respect to first clock signal 510 (as illustrated by adjustment 542), or later with respect to first clock signal 510 (as illustrated by adjustment 544). Understand while shown at this high level in the embodiment of FIG. 5, many variations and alternatives are possible.

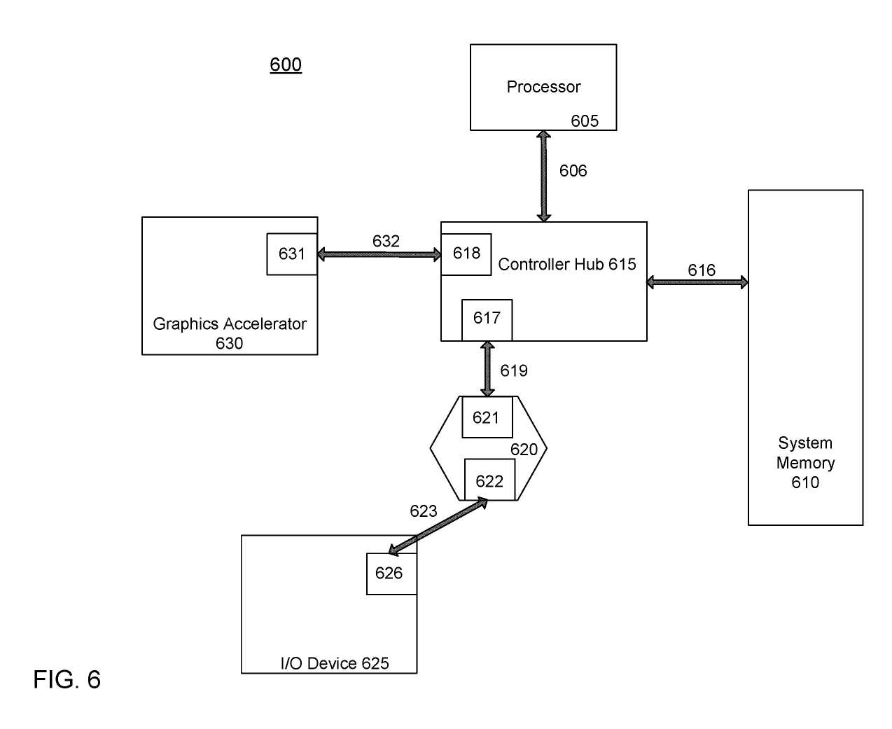

Embodiments may be implemented in a wide variety of interconnect structures. Referring to FIG. 6, an embodiment of a fabric composed of point-to-point links that interconnect a set of components is illustrated. System 600 includes processor 605 and system memory 610 coupled to controller hub 615. Processor 605 includes any processing element, such as a microprocessor, a host processor, an embedded processor, a co-processor, or other processor. Processor 605 is coupled to controller hub 615 through front-side bus (FSB) 606. In one embodiment, FSB 606 is a serial point-to-point interconnect. In another embodiment, link 606 includes a parallel serial, differential interconnect architecture that is compliant with different interconnect standards, and which may couple with one or more host controllers to perform delay determination and clock adjustments as described herein.

System memory 610 includes any memory device, such as random access memory (RAM), non-volatile (NV) memory, or other memory accessible by devices in system 600. System memory 610 is coupled to controller hub 615 through memory interface 616. Examples of a memory interface include a double-data rate (DDR) memory interface, a dual-channel DDR memory interface, and a dynamic RAM (DRAM) memory interface.

In one embodiment, controller hub 615 is a root hub, root complex, or root controller in a PCIe interconnection hierarchy. Examples of controller hub 615 include a chip set, a memory controller hub (MCH), a northbridge, an interconnect controller hub (ICH), a southbridge, and a root controller/hub. Often the term chip set refers to two physically separate controller hubs, i.e. a memory controller hub (MCH) coupled to an interconnect controller hub (ICH). Note that current systems often include the MCH integrated with processor 605, while controller 615 is to communicate with I/O devices, in a similar manner as described below. In some embodiments, peer-to-peer routing is optionally supported through root complex 615.

Here, controller hub 615 is coupled to switch/bridge 620 through serial link 619. Input/output modules 617 and 621, which may also be referred to as interfaces/ports 617 and 621, include/implement a layered protocol stack to provide communication between controller hub 615 and switch 620. In one embodiment, multiple devices are capable of being coupled to switch 620.

Switch/bridge 620 routes packets/messages from device 625 upstream, i.e., up a hierarchy towards a root complex, to controller hub 615 and downstream, i.e., down a hierarchy away from a root controller, from processor 605 or system memory 610 to device 625. Switch 620, in one embodiment, is referred to as a logical assembly of multiple virtual PCI-to-PCI bridge devices. Device 625 includes any internal or external device or component to be coupled to an electronic system, such as an I/O device, a Network Interface Controller (NIC), an add-in card, an audio processor, a network processor, a hard-drive, a storage device, a CD/DVD ROM, a monitor, a printer, a mouse, a keyboard, a router, a portable storage device, a Firewire device, a Universal Serial Bus (USB) device, a scanner, and other input/output devices and which may be coupled via an I3C bus, as an example. Often in the PCIe vernacular, such a device is referred to as an endpoint. Although not specifically shown, device 625 may include a PCIe to PCI/PCI-X bridge to support legacy or other version PCI devices. Endpoint devices in PCIe are often classified as legacy, PCIe, or root complex integrated endpoints.

Graphics accelerator 630 is also coupled to controller hub 615 through serial link 632. In one embodiment, graphics accelerator 630 is coupled to an MCH, which is coupled to an ICH. Switch 620, and accordingly I/O device 625, is then coupled to the ICH. I/O modules 631 and 618 are also to implement a layered protocol stack to communicate between graphics accelerator 630 and controller hub 615. A graphics controller or the graphics accelerator 630 itself may be integrated in processor 605.

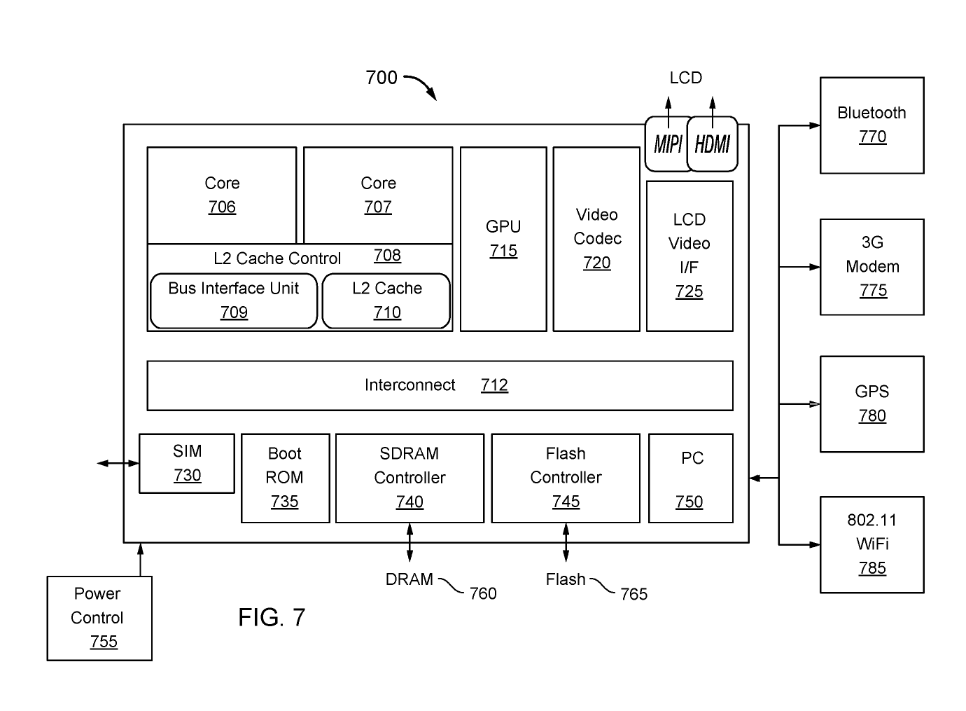

Turning next to FIG. 7, an embodiment of a SoC design in accordance with an embodiment is depicted. As a specific illustrative example, SoC 700 may be configured for insertion in any type of computing device, ranging from portable device to server system. Here, SoC 700 includes 2 cores 706 and 707. Cores 706 and 707 may conform to an Instruction Set Architecture, such as an Intel® Architecture Core™-based processor, an Advanced Micro Devices, Inc. (AMD) processor, a MIPS-based processor, an ARM-based processor design, or a customer thereof, as well as their licensees or adopters. Cores 706 and 707 are coupled to cache control 708 that is associated with bus interface unit 709 and L2 cache 710 to communicate with other parts of system 700 via an interconnect 712.

Interconnect 712 provides communication channels to the other components, such as a Subscriber Identity Module (SIM) 730 to interface with a SIM card, a boot ROM 735 to hold boot code for execution by cores 706 and 707 to initialize and boot SoC 700, a SDRAM controller 740 to interface with external memory (e.g., DRAM 760), a flash controller 745 to interface with non-volatile memory (e.g., flash 765), a peripheral controller 750 (e.g., an eSPI interface) to interface with peripherals, video codecs 720 and video interface 725 to display and receive input (e.g., touch enabled input), GPU 715 to perform graphics related computations, etc. Any of these interconnects/interfaces may incorporate aspects described herein, including delay determinations and clock control. In addition, the system illustrates peripherals for communication, such as a Bluetooth module 770, 3G modem 775, GPS 780, and WiFi 785. Also included in the system is a power controller 755.

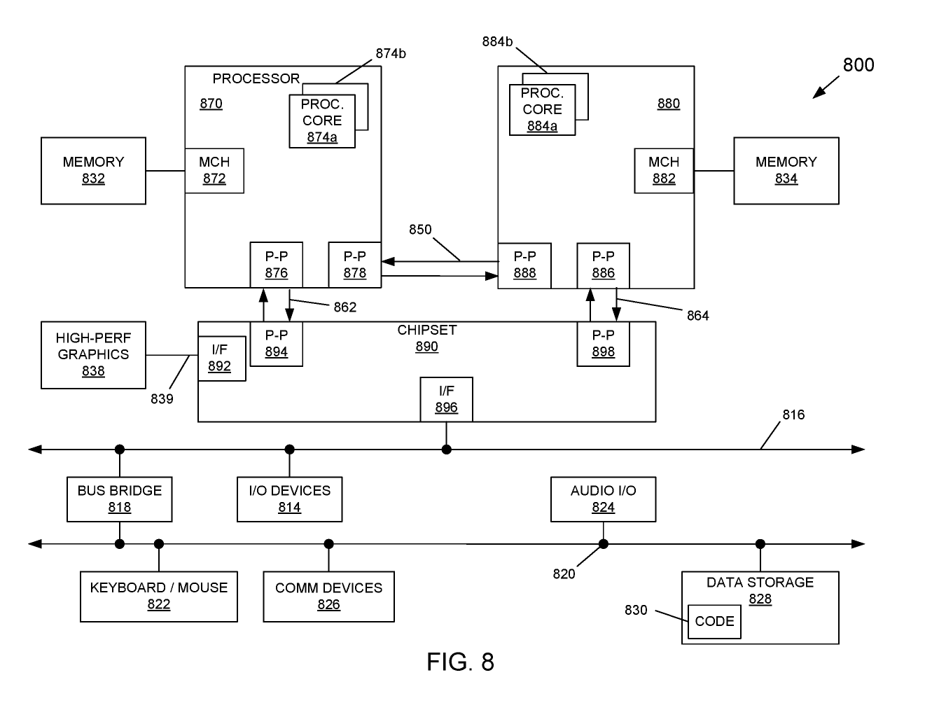

Referring now to FIG. 8, shown is a block diagram of a system in accordance with an embodiment of the present invention. As shown in FIG. 8, multiprocessor system 800 includes a first processor 870 and a second processor 880 coupled via a point-to-point interconnect 850. As shown in FIG. 8, each of processors 870 and 880 may be many core processors including representative first and second processor cores (i.e., processor cores 874a and 874b and processor cores 884a and 884b).

Still referring to FIG. 8, first processor 870 further includes a memory controller hub (MCH) 872 and point-to-point (P-P) interfaces 876 and 878. Similarly, second processor 880 includes a MCH 882 and P-P interfaces 886 and 888. As shown in FIG. 8, MCH's 872 and 882 couple the processors to respective memories, namely a memory 832 and a memory 834, which may be portions of system memory (e.g., DRAM) locally attached to the respective processors. First processor 870 and second processor 880 may be coupled to a chipset 890 via P-P interconnects 862 and 864, respectively. As shown in FIG. 8, chipset 890 includes P-P interfaces 894 and 898.

Furthermore, chipset 890 includes an interface 892 to couple chipset 890 with a high performance graphics engine 838, by a P-P interconnect 839. As shown in FIG. 8, various input/output (I/O) devices 814 may be coupled to first bus 816, along with a bus bridge 818 which couples first bus 816 to a second bus 820. Various devices may be coupled to second bus 820 including, for example, a keyboard/mouse 822, communication devices 826 and a data storage unit 828 such as a disk drive or other mass storage device which may include code 830, in one embodiment. Further, an audio I/O 824 may be coupled to second bus 820. Any of the devices shown in FIG. 8 may be configured to perform bus master activities (including the delay determination and clock control) for one or more of the interconnect structures, as described herein.

The following examples pertain to further embodiments.

In one example, an apparatus comprises a host controller to couple to an interconnect to which a plurality of devices may be coupled. The host controller may include: a first driver to drive first information onto the interconnect; a first receiver to receive second information from at least one of the plurality of devices via the interconnect; a read controller to adjust timing of a read clock based on a propagation delay timer value associated with a first device of the plurality of devices and communicate information on the interconnect with the first device using the adjusted read clock timing; and a link training controller to initiate a link training with the first device to determine the propagation delay timer value.

In an example, the host controller comprises a table having a plurality of entries each to store a propagation delay timer value for one of the plurality of devices.

In an example, the link training controller is to dynamically determine the propagation delay timer value for the first device.

In an example, the link training controller is to send a link training command to the first device to cause the first device to send an acknowledgement command to the host controller.

In an example, the link training controller is to determine the propagation delay timer value based on a time duration between a first time that the host controller is to send the link training command and a second time that the host controller is to receive the acknowledgement command.

In an example, the apparatus further comprises a timer to count the time duration according to a second clock, the second clock having a frequency substantially greater than the read clock.

In an example, the link training controller is to send a second propagation delay timer value associated with a second device of the plurality of devices, and the read controller is to adjust the timing of the read clock based on the second propagation delay timer value and communicate second information on the interconnect with the second device using the adjusted read clock timing, where the second propagation delay timer value is different than the propagation delay timer value.

In an example, the read controller comprises a first programmable circuit to adjust the read clock using the propagation delay timer value.

In an example, the host controller further comprises a write controller having a second programmable circuit to adjust a write clock to be provided to a write circuit of the host controller according to the propagation delay timer value, to maintain an inter-packet gap between a cycle of the write clock and a cycle of the read clock.

In an example, the link training controller is to dynamically determine a unique propagation delay timer value for the plurality of devices after the plurality of devices have been enumerated with address information.

In another example, a method comprises: identifying, via a host controller, a slave device having control of a bus that couples the slave device and the host controller; accessing a timer storage based on the identified slave device to obtain a timer value associated with the slave device; adjusting a timing of a read clock based on the timer value; and reading data received in the host controller from the slave device according to the adjusted timing of the read clock.

In an example, the method further comprises dynamically determining the timer value for the slave device based on a training.

In an example, the training comprises sending a first command from the host controller to the slave device to cause the slave device to send an acknowledgement command to the host controller.

In an example, the method further comprises determining the timer value based on a time duration between a first time at which the host controller sends the first command and a second time at which the host controller receives the acknowledgment command.

In an example, the method further comprises measuring the time duration according to a clock signal having a higher clock rate than the read clock.

In an example, the method further comprises communicating with a second slave device coupled to the host controller via the bus according to a second timer value, the second timer value different than the timer value, where the second slave device is located at a second distance with respect to the host controller, the first device located at a first distance with respect to the host controller, the first distance less than the second distance, the timer value less than the second timer value.

In another example, a computer readable medium including instructions is to perform the method of any of the above examples.

In another example, a computer readable medium including data is to be used by at least one machine to fabricate at least one integrated circuit to perform the method of any one of the above examples.

In another example, an apparatus comprises means for performing the method of any one of the above examples.

In a further example, a system comprises: a first device coupled to a host controller via a bus, where the first device is a first distance from the host controller; a second device coupled to the host controller via the bus, where the second device is a second distance from the host controller, the second distance greater than the first distance; and the host controller having a read controller to read data communicated from the first device with a read clock, a timing of the read clock adjusted according to a timer value associated with the first device.

In an example, the host controller comprises a table and a link training controller, the link timing controller to obtain the timer value from the table.

In an example, the link training controller is to send a first command to the first device to cause the first device to send an acknowledgement command to the host controller, and determine the timer value based on a time duration between a first time that the host controller is to send the first command and a second time that the host controller is to receive the acknowledgement command.

In an example, the system further comprises a timer to measure the time duration according to a second clock, the second clock having a higher clock rate than the read clock.

In yet another example, an apparatus comprises: means for accessing a storage means associated with a slave device having control of a bus to obtain a timer value associated with the slave device; means for adjusting a timing of a read clock based on the timer value; and means for reading data communicated from the slave device via the bus according to the adjusted timing of the read clock.

In an example, the apparatus further comprises means for dynamically determining the timer value for the slave device based on a training.

In an example, the apparatus further comprises means for sending a first command to the slave device to cause the slave device to send an acknowledgement command.

In an example, the apparatus further comprises means for determining the timer value based on a time duration between a first time at which the first command is sent and a second time at which the acknowledgment command is received.

In an example, the apparatus further comprises means for measuring the time duration according to a clock signal having a higher clock rate than the read clock.

Understand that various combinations of the above examples are possible.

Note that the terms “circuit” and “circuitry” are used interchangeably herein. As used herein, these terms and the term “logic” are used to refer to alone or in any combination, analog circuitry, digital circuitry, hard wired circuitry, programmable circuitry, processor circuitry, microcontroller circuitry, hardware logic circuitry, state machine circuitry and/or any other type of physical hardware component. Embodiments may be used in many different types of systems. For example, in one embodiment a communication device can be arranged to perform the various methods and techniques described herein. Of course, the scope of the present invention is not limited to a communication device, and instead other embodiments can be directed to other types of apparatus for processing instructions, or one or more machine readable media including instructions that in response to being executed on a computing device, cause the device to carry out one or more of the methods and techniques described herein.

Embodiments may be implemented in code and may be stored on a non-transitory storage medium having stored thereon instructions which can be used to program a system to perform the instructions. Embodiments also may be implemented in data and may be stored on a non-transitory storage medium, which if used by at least one machine, causes the at least one machine to fabricate at least one integrated circuit to perform one or more operations. Still further embodiments may be implemented in a computer readable storage medium including information that, when manufactured into a SoC or other processor, is to configure the SoC or other processor to perform one or more operations. The storage medium may include, but is not limited to, any type of disk including floppy disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. An apparatus comprising:
a host controller to couple to an interconnect to which a plurality of devices may be coupled, the host controller including:
a first driver to drive first information onto the interconnect;
a first receiver to receive second information from at least one of the plurality of devices via the interconnect;
a read controller to adjust timing of a read clock based on a propagation delay timer value associated with a first device of the plurality of devices and communicate information on the interconnect with the first device using the adjusted read clock timing; and
a link training controller to initiate a link training with the first device to determine the propagation delay timer value.

2. The apparatus of claim 1, wherein the host controller comprises a table having a plurality of entries each to store a propagation delay timer value for one of the plurality of devices.

3. The apparatus of claim 1, wherein the link training controller is to dynamically determine the propagation delay timer value for the first device.

4. The apparatus of claim 1, wherein the link training controller is to send a link training command to the first device to cause the first device to send an acknowledgement command to the host controller.

5. The apparatus of claim 4, wherein the link training controller is to determine the propagation delay timer value based on a time duration between a first time that the host controller is to send the link training command and a second time that the host controller is to receive the acknowledgement command.

6. The apparatus of claim 5, further comprising a timer to count the time duration according to a second clock, the second clock having a frequency substantially greater than the read clock.

7. The apparatus of claim 1, wherein the link training controller is to send a second propagation delay timer value associated with a second device of the plurality of devices, and the read controller is to adjust the timing of the read clock based on the second propagation delay timer value and communicate second information on the interconnect with the second device using the adjusted read clock timing, wherein the second propagation delay timer value is different than the propagation delay timer value.

8. The apparatus of claim 1, wherein the read controller comprises a first programmable circuit to adjust the read clock using the propagation delay timer value.

9. The apparatus of claim 8, wherein the host controller further comprises a write controller having a second programmable circuit to adjust a write clock to be provided to a write circuit of the host controller according to the propagation delay timer value, to maintain an inter-packet gap between a cycle of the write clock and a cycle of the read clock.

10. The apparatus of claim 1, wherein the link training controller is to dynamically determine a unique propagation delay timer value for the plurality of devices after the plurality of devices have been enumerated with address information.

11. At least one computer readable storage medium comprising instructions that when executed enable a system to:
identify, via a host controller, a slave device having control of a bus that couples the slave device and the host controller;
access a timer storage based on the identified slave device to obtain a timer value associated with the slave device;
adjust a timing of a read clock based on the timer value; and
read data received in the host controller from the slave device according to the adjusted timing of the read clock.

12. The at least one computer readable storage medium of claim 11, further comprising instructions that when executed enable the system to dynamically determine the timer value for the slave device based on a training.

13. The at least one computer readable storage medium of claim 12, wherein the training comprises to send a first command from the host controller to the slave device to cause the slave device to send an acknowledgement command to the host controller.

14. The at least one computer readable storage medium of claim 13, further comprising instructions that when executed enable the system to determine the timer value based on a time duration between a first time at which the host controller sends the first command and a second time at which the host controller receives the acknowledgment command.

15. The at least one computer readable storage medium of claim 14, further comprising instructions that when executed enable the system to measure the time duration according to a clock signal having a higher clock rate than the read clock.

16. The at least one computer readable storage medium of claim 11, further comprising instructions that when executed enable the system to communicate with a second slave device coupled to the host controller via the bus according to a second timer value, the second timer value different than the timer value, wherein the second slave device is located at a second distance with respect to the host controller, the first device located at a first distance with respect to the host controller, the first distance less than the second distance, the timer value less than the second timer value.

17. A system comprising:
a first device coupled to a host controller via a bus, wherein the first device is a first distance from the host controller;
a second device coupled to the host controller via the bus, wherein the second device is a second distance from the host controller, the second distance greater than the first distance; and
the host controller having a read controller to read data communicated from the first device with a read clock, a timing of the read clock adjusted according to a timer value associated with the first device.

18. The system of claim 17, wherein the host controller comprises a table and a link training controller, the link timing controller to obtain the timer value from the table.

19. The system of claim 18, wherein the link training controller is to send a first command to the first device to cause the first device to send an acknowledgement command to the host controller, and determine the timer value based on a time duration between a first time that the host controller is to send the first command and a second time that the host controller is to receive the acknowledgement command.

20. The system of claim 19, further comprising a timer to measure the time duration according to a second clock, the second clock having a higher clock rate than the read clock.
